(19) United States
(12) Patent Application Publication
(10) Pub. No.: US 2026/0258841 A1
(43) Pub. Date: Sep. 3, 2026

(54) THIN-RING BEARING AND COMPUTED TOMOGRAPHY UNIT WITH SUCH A THIN-RING BEARING

(71) Applicant: Schaeffler Technologies AG & Co. KG, Herzogenaurach (DE)

(72) Inventors: Wolfgang Braun, Garstadt (DE); Michael Pausch, Dittelbrunn (DE); Dietmar Rudy, Kleinbundenbach (DE); Carsten Merklein, Nürnberg (DE)

(73) Assignee: Schaeffler Technologies AG & Co. KG, Herzogenaurach (DE)

(21) Appl. No.: 18/872,856

(22) PCT Filed: Jan. 31, 2023
(86) PCT No.: PCT/DE2023/100072

§ 371 Date: Dec. 9, 2024

(30) Foreign Application Priority Data
Jul. 8, 2022 (DE) 10 2022 117 033.0

(51) Int. Cl. F16C 33/62; F16C 19/06

(52) U.S. Cl. CPC F16C 33/62; F16C 19/06; F16C 33/60; F16C 33/585; F16C 2202/04; F16C 2204/62; F16C 2220/24; F16C 2223/02; F16C 2223/10; F16C 2223/46; F16C 2300/14; F16C 2316/10

(57) ABSTRACT

A thin-ring bearing, in particular for a computed tomography unit, comprising has at least one outer ring, at least one inner ring and a plurality of spherical rolling bodies. The at least one inner ring is formed with an inside diameter of greater than 700 mm, wherein the at least one inner ring and the at least one outer ring are formed from an unhardened metallic base material with a hardness of less than 60 HRC. The at least one inner ring and the at least one outer ring each form a raceway receiving surface, wherein the base material is at least partially covered with a functional layer of a functional layer thickness in the range from 0.5 to 3 mm in the region of the raceway receiving surfaces, wherein the functional layer is formed from a metallic functional layer material with a hardness of at least 60 HRC.

### CROSS-REFERENCE TO RELATED APPLICATIONS

This application is the U.S. National Phase of PCT Appln. No. PCT/DE2023/100072 filed Jan. 31, 2023, which claims priority to DE 10 2022 117 033.0 filed Jul. 8, 2022, the entire disclosures of which are incorporated by reference herein.

### TECHNICAL FIELD

The disclosure relates to a thin-ring bearing comprising at least one outer ring, at least one inner ring and a plurality of spherical rolling elements, wherein the at least one inner ring is formed with an inside diameter of greater than 700 mm, in particular for use in a computed tomography unit.

### BACKGROUND

DE102009056038 A1 describes a thin-ring bearing and a method of manufacturing a bearing ring from wire-shaped material for a thin-ring bearing.

Thin-ring bearings are rolling bearings that have a large inside diameter Dᵢ of the inner ring in relation to the distance A between the inside diameter and the outside diameter of the bearing (viewed in cross-section). In particular, the ratio of A/Dᵢ=1:30 to 1:150.

DE 10 2017 222 208 B3 discloses a computed tomography device and a method for arranging a bearing ring of a rolling bearing. The rolling bearing is designed as a three-point ball bearing and has a bearing ring with a groove profile, a first wire ring and a second wire ring. Such computed tomography devices typically have a stationary part and a rotating part, wherein the rotating part has a radiation source for X-ray radiation and a detector for the X-ray radiation which works in combination with the radiation source. The rotating part can have a mass of around 600 to 900 kg and rotate at a speed of around 60 to 240 revolutions per minute. A rolling bearing can be used for the rotary bearing of the rotating part relative to the stationary part.

In this regard, a high degree of running accuracy, extremely smooth running, zero backlash and a high degree of tilting rigidity are essential in order to produce high-quality images. To date, bearing rings made of high-purity and therefore expensive steel grades have been used for this purpose.

### SUMMARY

It is therefore the object of the disclosure to provide a suitable thin-ring bearing that allows for significant cost savings in terms of its manufacture.

The object is achieved for the thin-ring bearing comprising at least one outer ring, at least one inner ring and a plurality of spherical rolling elements, wherein the at least one inner ring is formed with an inside diameter of greater than 700 mm, in that the at least one inner ring and the at least one outer ring are formed from an unhardened metallic base material with a hardness of less than 60 HRC, and wherein the at least one inner ring and the at least one outer ring each form a raceway receiving surface, wherein the base material is at least partially covered with a functional layer of a functional layer thickness in the range from 0.5 to 3 mm in the region of the raceway receiving surfaces, and wherein the functional layer is formed from a metallic functional layer material with a hardness of at least 60 HRC.

This means that only the functional layer can be formed by a high-quality, very pure and resistant to overrolling functional layer material of high hardness. As the functional layer material can be applied separately and in a thin functional layer thickness, the material-related manufacturing costs for the bearing rings are significantly reduced. In this regard, the functional layer thickness of the functional layer is selected according to the minimum hardening depth required on the respective ring in order to create a functional and durable component. The base material to which the functional layer is applied no longer has to meet the high purity requirements. Stresses and distortion can also be minimized without having to subject the entire bearing ring to a heat treatment.

The metallic base material is preferably formed from steel. The metallic base material is selected in particular from rolling bearing steel, quenched and tempered steel or case-hardened steel. For example, a weldable quenched and tempered steel with a carbon content of less than 0.3% by weight is used. Alternatively, aluminum can also be used as a metallic base material.

The metallic functional layer material is preferably a steel with the following constituents:
0 to 10% by weight Mo,
0 to 19% by weight W,
0 to 5% by weight V,
3.5 to 5% by weight Cr,
0-11% by weight Co,
0.75 to 1.2% by weight C,
with the remainder being made up of iron and unavoidable impurities or other elements, such as Mn, Si, Cu, Ni, P, S, in a proportion of less than 0.5% by weight.

In particular, steel of the type 1.3344 (X 130 WMoCrV 6-5-4-3) is used. Powder-metallurgical high-speed steels with high hardness are preferred.

Alternatively, the metallic functional layer material is preferably a hard metal based on tungsten carbide in a nickel binding matrix, also known on the market as “Cermadur”.

A combination of a metallic base material in the form of quenched and tempered steel with a carbon content of less than 0.3% by weight with a functional layer material made of steel of the type 1.3344 is particularly preferred here.

The functional layer is applied to the base material in particular by means of laser deposition welding. This results in a wavy structure in the transition region between the base material and the functional layer, which is recognizable in the micrograph and can be influenced by the process parameters during laser deposition welding. The resulting heat-affected zone extends into the base material, wherein the waviness extends over a region corresponding to the measured distance Z between a mean value of the wave peaks and a mean value of the wave troughs, wherein this distance Z is at least 50 μm. This ensures a particularly close and pore-free bond between the base material and the functional layer. The waviness and expansion of the heat-affected zone depends on the application parameters, such as power, application speed and application width.

A free surface of the functional layer, which forms the raceway for the rolling elements, is preferably reworked by machining and/or is roller-burnished. In this manner, the flatness and surface roughness of the free surface of the functional layer and thus the raceways are adapted to the requirements with respect to the application of the rolling bearing components. In particular, the free surface of the functional layer is ground and honed.

The at least one outer ring and/or at least one inner ring can also be heat-treated in order to optimize the tension on the ring and also increase the hardness of the functional layer material. In particular, heat treatment is carried out in a temperature range of 400° C. to less than 600° C. over 1 to 2 hours. The at least one outer ring and/or at least one inner ring is then cooled to room temperature. In the case of a particularly preferred combination of a metallic base material in the form of quenched and tempered steel with a carbon content of less than 0.3% by weight with a functional layer material made of steel of the type 1.3344, this heat treatment is preferably carried out in a temperature range of 500° C. to less than 600° C.

The raceway receiving surfaces are preferably covered with the functional layer only in a contact region with respect to the rolling elements. This saves on functional layer material and further reduces the cost of a bearing ring.

The functional layer thickness can also be formed in a differing manner as viewed over a cross-section of a raceway receiving surface, which further reduces costs.

It is preferred that two outer rings and/or two inner rings are provided. This makes it considerably easier to mount the thin-ring bearing at the place of use.

The thin-ring bearing is designed in particular with a square or predominantly square cross-section. The thin-ring bearing is preferably designed as a deep groove ball bearing, a four-point bearing or an angular contact ball bearing.

A computed tomography unit comprising at least one thin-ring bearing according to the disclosure has proven successful. With regard to a possible design of a computed tomography unit, reference is made to DE 10 2017 222 208 B3 mentioned at the outset.

### BRIEF DESCRIPTION OF THE DRAWINGS

FIGS. 1 to 3 are intended to illustrate a thin-ring bearing according to the disclosure by way of example. In the figures:

FIG. 1 shows a section through a thin-ring bearing,

FIG. 2 shows an enlarged detail from FIG. 1, and

FIG. 3 shows a micrograph of a section through the functional layer and the adjoining base material.

### DETAILED DESCRIPTION

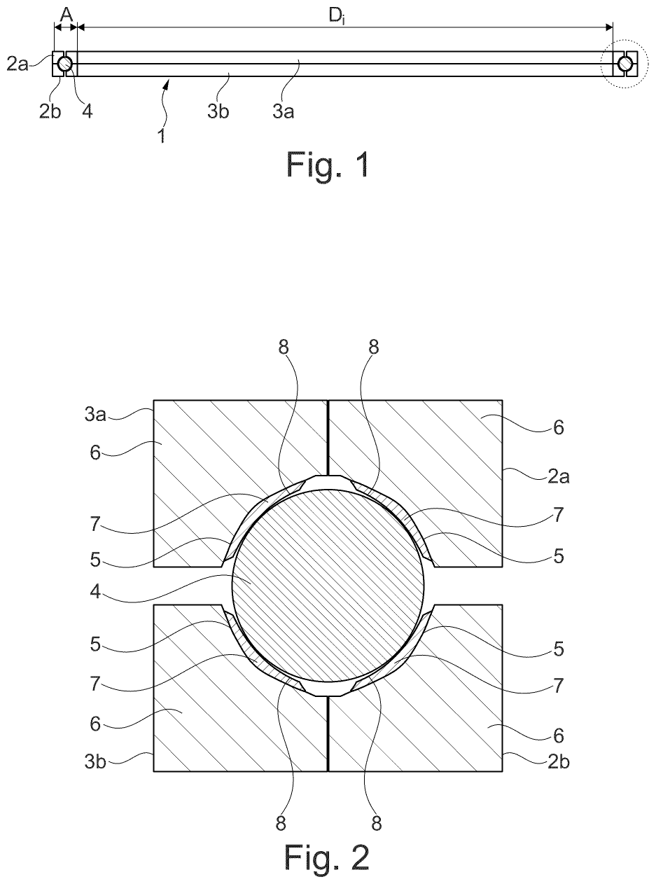

FIG. 1 shows a section through a thin-ring bearing 1 with a split outer ring 2a, 2b, a split inner ring 3a, 3b and rolling elements 4. The inside diameter Dᵢ of the split inner ring 3a, 3b is designed to be greater than 1 m. The distance A between the inside diameter Dᵢ and the outside diameter of the split outer ring 2a, 2b is only 30 mm, resulting in a ratio of A/Dᵢ of at least 1:34. The cross-section of the thin-ring bearing 1 (see the area marked with a dotted line) is shown enlarged in FIG. 2.

FIG. 2 shows this enlarged detail from FIG. 1. The same reference signs as in FIG. 1 indicate identical components. The split outer ring 2a, 2b made of a base material 6 and with the raceway receiving surfaces 5 can be seen. The split inner ring 3a, 3b made of a base material 6 and with the raceway receiving surfaces 5 can also be seen. The functional layers 7 made of a functional layer material are applied to the raceway receiving surfaces 5 in each case. In this regard, the functional layer 7 is applied with different functional layer thicknesses as viewed over the cross-section of a raceway receiving surface 5. In addition, the functional layer 7 does not completely cover the respective raceway receiving surface 5. This saves on functional layer material and reduces the cost of the thin-ring bearing 1.

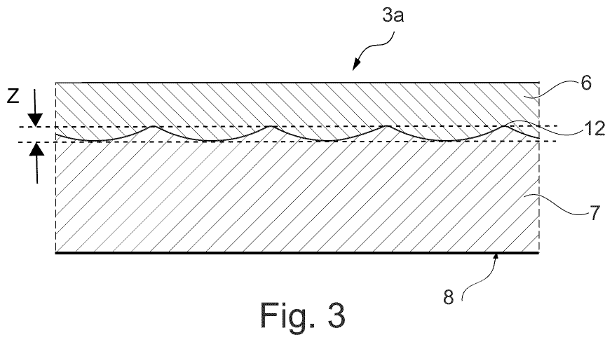

FIG. 3 shows a micrograph of a section through the functional layer 7 and the adjoining base material 6 of the inner ring 3a. The functional layer 7 is formed on the base material 6 by means of laser deposition welding. A wavy structure is present in the transition region 12, in which the base material 6 is fused with the functional layer 7. The distance Z between the mean value of the wave peaks and the mean value of the wave troughs (see dashed lines) is at least 50 μm. The free surface 8 of the functional layer 7, which faces away from the base material 6, has been reworked here by grinding and honing. The free surface 8 of the functional layer 7 is presented as flat here for the sake of simplicity, although it has a curvature in the thin-ring bearing 1 in order to receive the rolling elements 4 in the form of balls.

List of reference signs

| | |
|---|---|
| 1 | Thin-ring bearing |
| 2a, 2b | Outer ring |
| 3a, 3b | Inner ring |
| 4 | Rolling element |
| 5 | Raceway receiving surface |
| 6 | Base material |
| 7 | Functional layer |
| 8 | Free surface of the functional layer |
| 12 | Transition region |
| A | Distance |
| Dᵢ | Inside diameter |

1. A thin-ring bearing comprising at least one outer ring, at least one inner ring and a plurality of spherical rolling elements, wherein the at least one inner ring is formed with an inside diameter of greater than 700 mm, wherein the at least one inner ring and the at least one outer ring are formed from an unhardened metallic base material with a hardness of less than 60 HRC, and wherein the at least one inner ring and the at least one outer ring each form a raceway receiving surface, wherein the base material is at least partially covered with a functional layer of a functional layer thickness in the range from 0.5 to 3 mm in the region of the raceway receiving surfaces, wherein the functional layer is formed from a metallic functional layer material with a hardness of at least 60 HRC.

2. The thin-ring bearing according to claim 1, wherein the metallic base material is formed from steel.

3. The thin-ring bearing according to claim 1, wherein the metallic functional layer material is formed from steel of the type 1.3344 (X 130 WMoCrV 6-5-4-3) or from a hard metal based on tungsten carbide in a nickel binding matrix.

4. The thin-ring bearing according to claim 1, wherein the functional layer is applied to the base material by means of laser deposition welding, whereby a wavy transition region is formed between the base material and the functional layer when viewed in section.

5. The thin-ring bearing according to claim 1, wherein a free surface of the functional layer, which forms a raceway for the rolling elements, is reworked by machining and/or is roller-burnished.

6. The thin-ring bearing according to claim 1, wherein the at least one outer ring and/or at least one inner ring is heat-treated.

7. The thin-ring bearing according to claim 1, wherein the raceway receiving surfaces are covered with the functional layer only in a contact region with respect to the rolling elements.

8. The thin-ring bearing according to claim 1, wherein two outer rings and/or two inner rings are provided.

9. The thin-ring bearing according to claim 1, wherein the functional layer thickness is formed in a differing manner as viewed over a cross-section of a raceway receiving surface.

10. A computed tomography unit comprising at least one thin-ring bearing according to claim 1.
